(19) United States
(12) Patent Application Publication
(10) Pub. No.: US 2016/0307457 A1
(43) Pub. Date: Oct. 20, 2016

(54) SYSTEM AND METHOD FOR ONLINE ACTING REHEARSALS

(71) Applicant: WeRehearse Inc., Westlake Village, CA (US)

(72) Inventors: Jessica Lee Rose, Melbourne (AU); Darren Darnborough, Los Angeles, CA (US); Richard John Cambridge Harbutt, Bristol (GB)

(21) Appl. No.: 15/099,461

(22) Filed: Apr. 14, 2016

Related U.S. Application Data
(60) Provisional application No. 62/147,559, filed on Apr. 14, 2015.

(51) Int. Cl. G09B 19/00; H04N 21/482; H04N 21/4788; G09B 5/06; H04N 21/2543

(52) U.S. Cl. CPC G09B 19/00; G09B 5/065; H04N 21/2543; H04N 21/4788; H04N 21/4828

(57) ABSTRACT

A system and method for online acting rehearsals including a platform that allows a user to search for and/or request a rehearsal partner. Once a pairing has been made, the system and method allows for an online rehearsal setting as well as effecting payment. Additional features include the ability to upload written material (script or scene) and rate and tip users.

### CROSS REFERENCE TO RELATED APPLICATION

This application claims priority to U.S. Provisional Application No. 62/147,559, filed Apr. 14, 2015, which is hereby incorporated by reference in its entirety as if fully recited herein.

### BACKGROUND OF THE INVENTION

Acting requires continual learning, practice and refinement of the craft. Often, much improvement comes from rehearsals with other actors. Unfortunately, coordinating with other actors to prepare, meet, and rehearse together in person can be a difficult task; logistically, for example. Issues such as the cost of making arrangements, conflicting schedules, or incompatibility between performers can complicate the process and hinder the acting professional's ability to hone his or her craft. Moreover, auditions and script changes regularly arrive at the eleventh hour, further complicating rehearsal coordination for adequate preparation.

The traditional acting class, in which a group of students meet at a particular time and pay a predetermined fee to participate, does not fully address this problem. Such classes can be costly, infrequent, and focused on material chosen by an instructor, which material may not be relevant to each actor's growth or tailored to his or her needs. If an actor wants to vary any of these parameters, such as to rehearse different material, negotiate or tailor a fee, or rehearse on a different schedule, he or she will often find traditional acting classes unable to accommodate his or her specific needs.

Current online video chat programs do not fully address the problem either. While such programs do allow for face-to-face videoconferencing whenever two persons should so arrange, they do not help actors find other actors or provide services unique to the acting community.

One related system is shown in European Patent Union Application EP 1 924 051 A1, which is incorporated by reference herein in its entirety. This patent generally teaches an interactive framework for non-real-time audio/video collaboration. While this system and method may provide for web-based, time-independent videoconferencing across multimedia platforms, complete with different “rooms” participants can join, one notable drawback of this system and method is that it neither provides for real-time rehearsal opportunities nor the ability for users to transfer or receive payment for services, among other drawbacks.

Another related system is generally disclosed in U.S. Pat. No. 7,185,054 B1, which is incorporated herein by reference. This patent generally teaches a system and method wherein participants to a videoconference can select certain parameters for participants. However, one drawback of these teachings is that there is, again, no means for the users to arrange payment or receive payment for services nor a passive participant mode, among others.

Another related system is shown by U.S. Pat. No. 7,877,353 B2, which is incorporated by reference herein in its entirety. This patent generally teaches a peer-to-peer reputation-based trading system wherein users can evaluate each other's content and serve as either the paying party or the profiting party. However, these teachings do not provide for real-time video conferencing nor purely observational functionality, for example.

Thus, there is a need for a system and method for online acting rehearsals that overcomes the noted deficiencies in the related art, among others.

### SUMMARY OF THE INVENTION

In accordance with the present invention, various embodiments of a system and method for online acting rehearsals are disclosed. In various embodiments, not limited to any sequence or number of steps, users may use software embodying one or more embodiment to choose their acting rehearsal experience. Numerous exemplary embodiments are disclosed herein.

One exemplary embodiment may preferably include a “Rehearsing” online acting rehearsal in which a user searches for an acting partner or coach, arranges or books a time for the rehearsal, verifies his or her payment, uploads a script or other form of dramatic material for use during the rehearsal, participates in the interactive acting rehearsal, and then tips the acting partner or coach if the user so desires.

Another exemplary embodiment may preferably include a “Learning” online acting rehearsal experience in which a user books a time to observe a particular performance, pays for the observation time, observes the performance and may preferably be allowed to ask questions, and then rate the experience. Such “learning” experiences can also include sponsored content intended for a wide audience, such as a seminar or workshop series.

Another exemplary embodiment may preferably include an “Earning” online acting rehearsal experience, in which a user agrees to read or advise a particular piece of material at a particular time using the system and method in which the user agrees to be compensated for the performance, the user performs at the agreed-upon time and in the agreed-upon manner, and receives compensation for doing so.

The present system and method accomplishes these and other functionalities via several computer applications. In one embodiment, the present system and method may preferably rely on the MySQL network for developmental structure and an Ajax server interface to maintain the “live” quality of the online interactive acting experience. In alternate embodiments the present system and method may preferably utilize any one or all of the LAMP (Linux, Apache, My SQL, and Perl/PHP/Python) open source web application software in addition to or in place of MySQL alone.

The present system and method may also preferably utilize the in-browser plugin WebRTC for the videoconferencing capability. WebRTC generally does not require any further plug-ins, or require use of a second videoconferencing program. WebRTC allows for direct communication between participants, allowing for crisper images and better sound quality. Moreover, WebRTC has very low latency, i.e., delay is reduced for a near real-time experience. In addition, the present system and method may also preferably integrate OpenTok software into the WebRTC plugin. The present system and method may also preferably use PayPal® API to facilitate funds transfers between users. Furthermore, the present system and method may preferably utilize Twillo to enable users to text or SMS messages as part of the user experience with certain embodiments of the system and method.

The above summary is not intended to represent each embodiment or every aspect of the present invention. Particular embodiments may include one, some, or none of the listed advantages.

Further, the summary presented herein is to introduce a number of concepts in a simplified form and is not intended to identify key, necessary, or essential features of the claimed subject matter, nor is it intended to be used to limit the scope of the claimed subject matter. As such, the claimed subject matter is not limited to implementations that solve any or all disadvantages noted in any part of this disclosure.

### BRIEF DESCRIPTION OF THE DRAWINGS

A more complete understanding of the present invention may be obtained by reference to the Detailed Description when taken in conjunction with the accompanying Drawings wherein:

FIG. 1 is an illustration of an embodiment of a system and method for online interactive acting showing a block diagram illustrating an exemplary sequence wherein the system and method is used for a “rehearsing” function;

FIG. 2 is an illustration of an embodiment of a system and method for online interactive acting showing a block diagram illustrating an exemplary sequence wherein the system and method is used for a “learning” function;

FIG. 3 is an illustration of an embodiment of a system and method for online interactive acting showing a block diagram illustrating three exemplary sequences wherein the system and method is used for an “earning” function;

FIG. 4 is a flow chart of one aspect of the “rehearsing” function where a user can make a request for another user;

FIGS. 5-11 are exemplary screenshots of a mobile application embodying various aspects of the present invention.

### DETAILED DESCRIPTION OF THE INVENTION

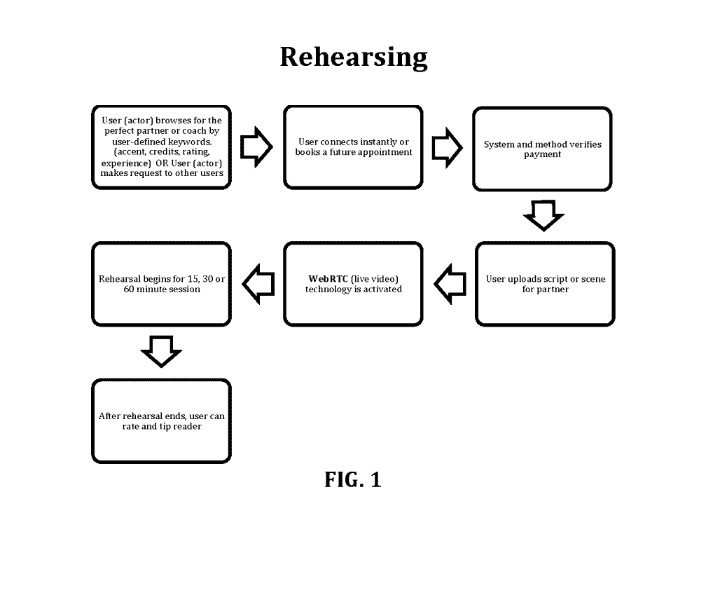

Referring now to FIG. 1, an illustration of an embodiment of a system and method for online acting rehearsals showing a block diagram illustrating an exemplary sequence wherein the system and method is used for a “rehearsing” function is shown. In the exemplary embodiment shown in FIG. 1, the user begins by browsing for an acting partner or coach via user-defined keywords. Such keywords may preferably include such categories as accents, screen credits, rating according to an independent or native metric, or years of acting experience. The user then arranges for a rehearsal time, either at that moment or in the future, then pays the allotted fee. Alternatively, the user (actor) can put a request out to another user (reader). In this scenario, the other users (reader) would get notified and respond (if available to be shortlisted). The user (actor) would then pick among the available users (readers) and are connected to interact in an online rehearsal video-chat room. The payment is then verified by the system and method. The user then may preferably upload a script or a scene for the rehearsal, allowing the rehearsal partner to be able to familiarize her or himself with the written material. The WebRTC (live video) technology or similar software is then activated. The rehearsal then takes place, either at that moment or at a time in the future. During the rehearsal, the user and his or her partner(s) share real-time video and audio in a format conducive to an online acting rehearsal experience, and the rehearsal can be as long or a short in duration of time as the user should choose, preferably in segments of 15, 30, or 60 minutes. At the conclusion of the rehearsal, the user may choose to tip the partner is she or he should so choose along with the fee, if the fee had been previously set.

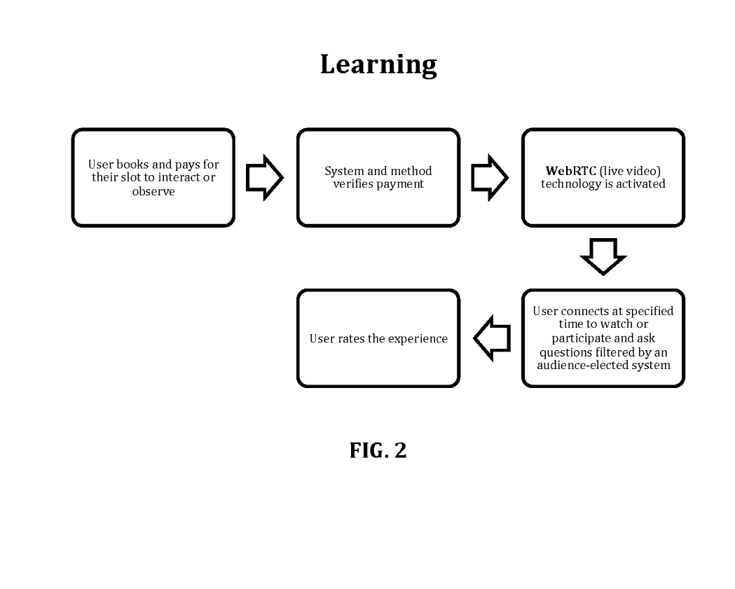

Referring now to FIG. 2, an embodiment of a system and method for online acting rehearsals showing a block diagram illustrating an exemplary sequence wherein the system and method is used for a “learning” function is shown. In the exemplary embodiment shown in FIG. 2, the user begins by searching for an appropriate acting experience to observe. The user then pays the allotted fee, and the system and method verifies the payment. Then, the WebRTC software or similar software is activated. The user then observes the session and preferably is able to ask questions of the performers at an appropriate time, such as when the session has concluded. At the conclusion of the session, the user is also given the option of rating the session.

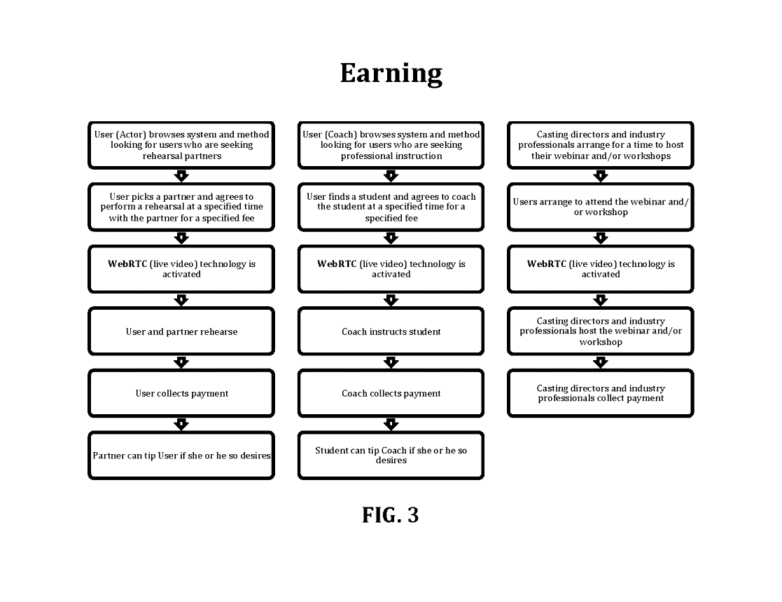

Referring now to FIG. 3, an illustration of an embodiment of a system and method for online acting rehearsals showing a block diagram illustrating three exemplary sequences wherein the system and method is used for an “earning” function is shown. In the first sequence of the embodiment disclosed in FIG. 3, the user may preferably search the system and method for users who are seeking rehearsal partners. Once the user has found such a partner, the user then agrees to perform a rehearsal at a specified time with the partner for a specified fee. At the time of the rehearsal, the WebRTC software or similar software is then activated. The user and partner then rehearse together online using the WebRTC or similar software, and the user is compensated using the system and method. The partner may preferably be given the ability to tip the user, should the partner so desire.

Continuing with FIG. 3, in the second sequence of the exemplary “earning” embodiment of a system and method for online acting rehearsals as illustrated by block diagram in FIG. 3, the user, such as a coach, may preferably browse the system and method looking for students seeking professional instruction. Once the user has found an appropriate student, the user agrees to instruct the student at a specified time for a specified fee. At the specified time, WebRTC software or similar software is activated. The user then instructs the student and collects payment using the system and method. The student may preferably be given the ability to tip the user, if the student should so desire.

Continuing with FIG. 3, in the third sequence of the exemplary “earning” embodiment of a system and method for online acting rehearsals as illustrated by block diagram in FIG. 3, a user such as a casting director or industry professional may preferably arrange for a time to host a webinar and/or workshop using the system and method disclosed herein. Other users (participants) then arrange to attend the webinar and/or workshop. At the specified time, WebRTC software or similar software is activated. The casting director or industry professional then hosts the webinar and/or workshop and collects a payment for doing so using the system and method.

In a preferred embodiment, the system and method can allow payment to be authorized prior to rehearsal and payment completed in accordance with the authorization after rehearsal.

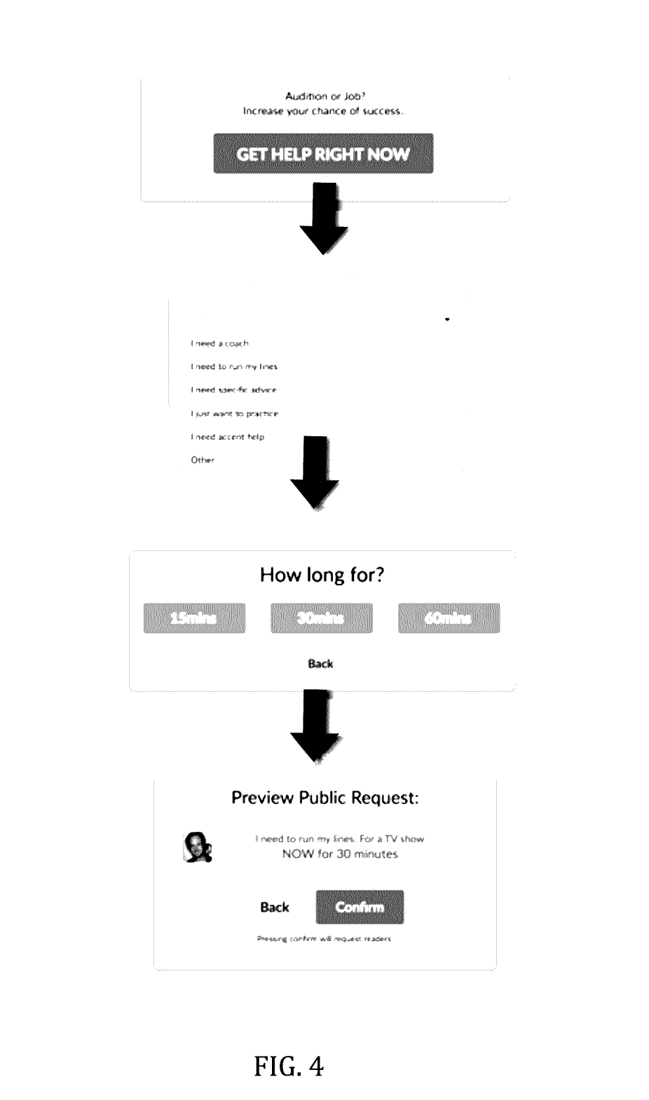

FIG. 4 is a flow chart of one aspect of the “rehearsing” function where a user can make a request for another user. As can be seen from FIG. 4, a user can make an instant request to other users to get assistance. The user can also select what type of help they need, i.e., a coach, a rehearsal partner, specific advice, accent help, for example. The user can also select the duration of the rehearsal period. Once certain criteria are selected, the user can confirm and submit the request.

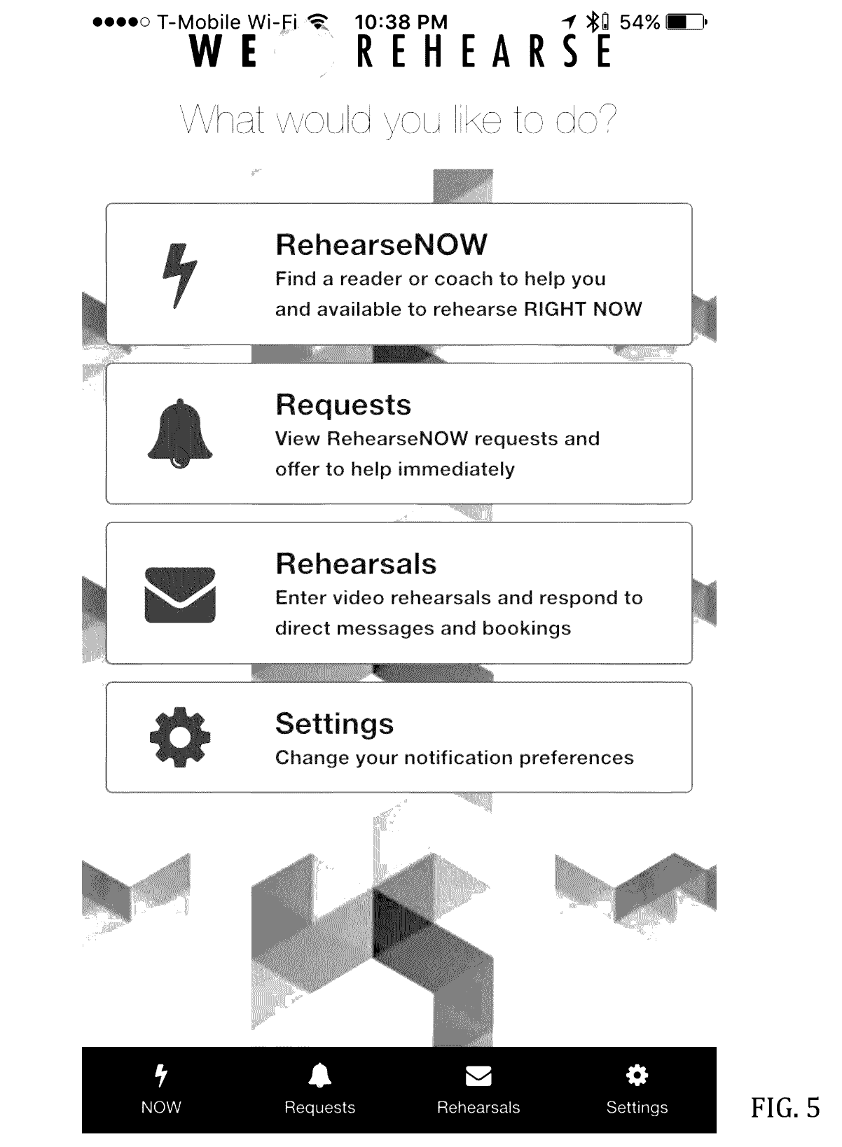

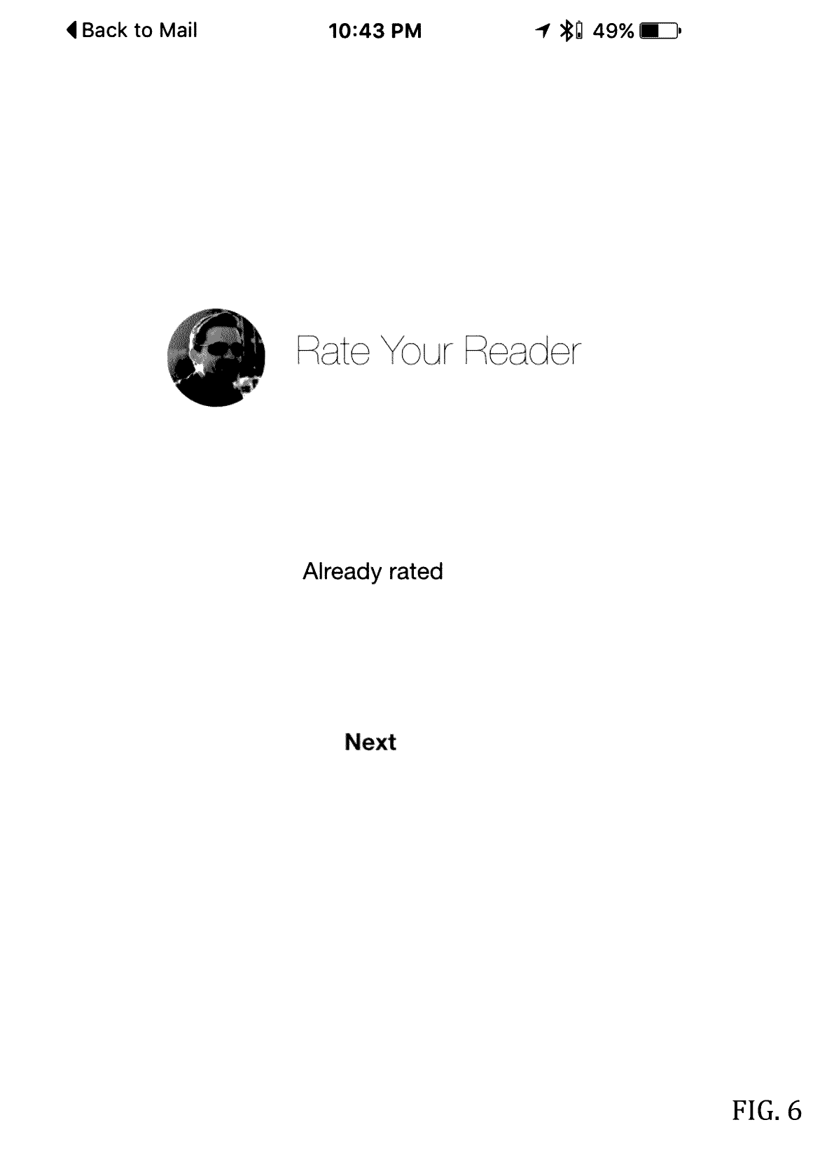

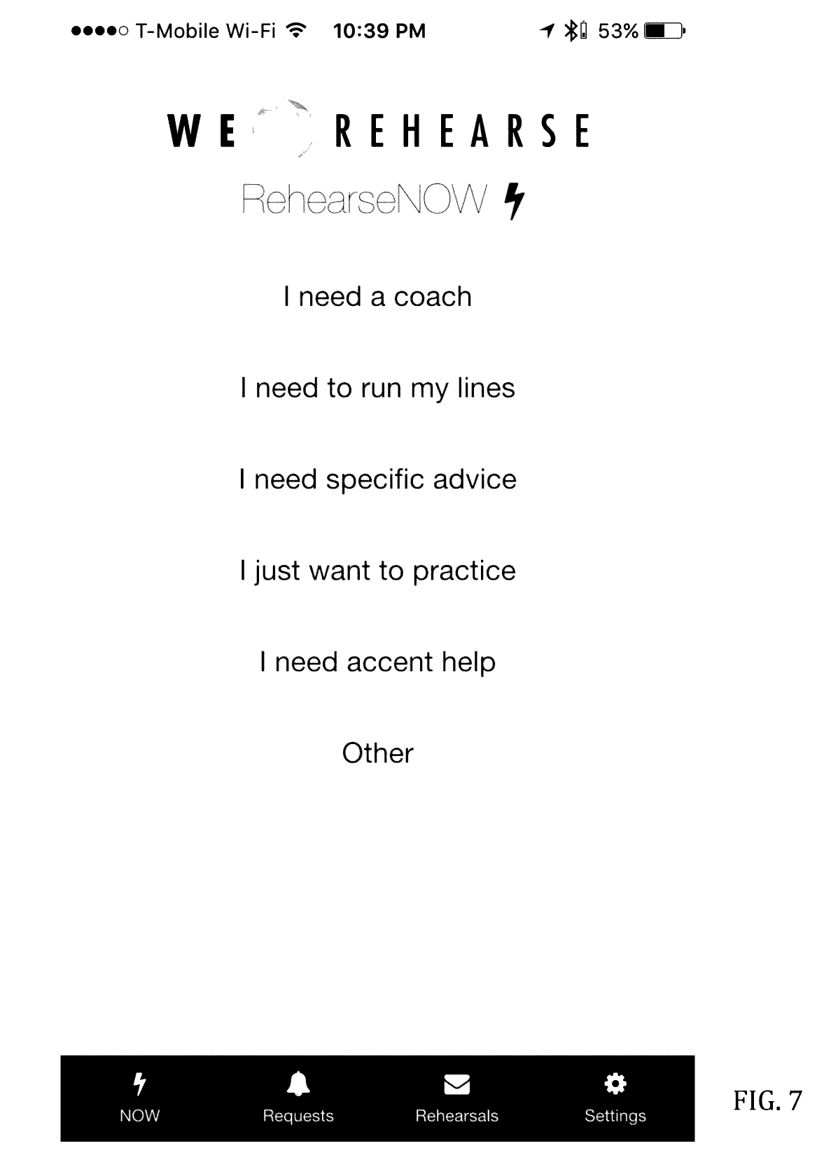

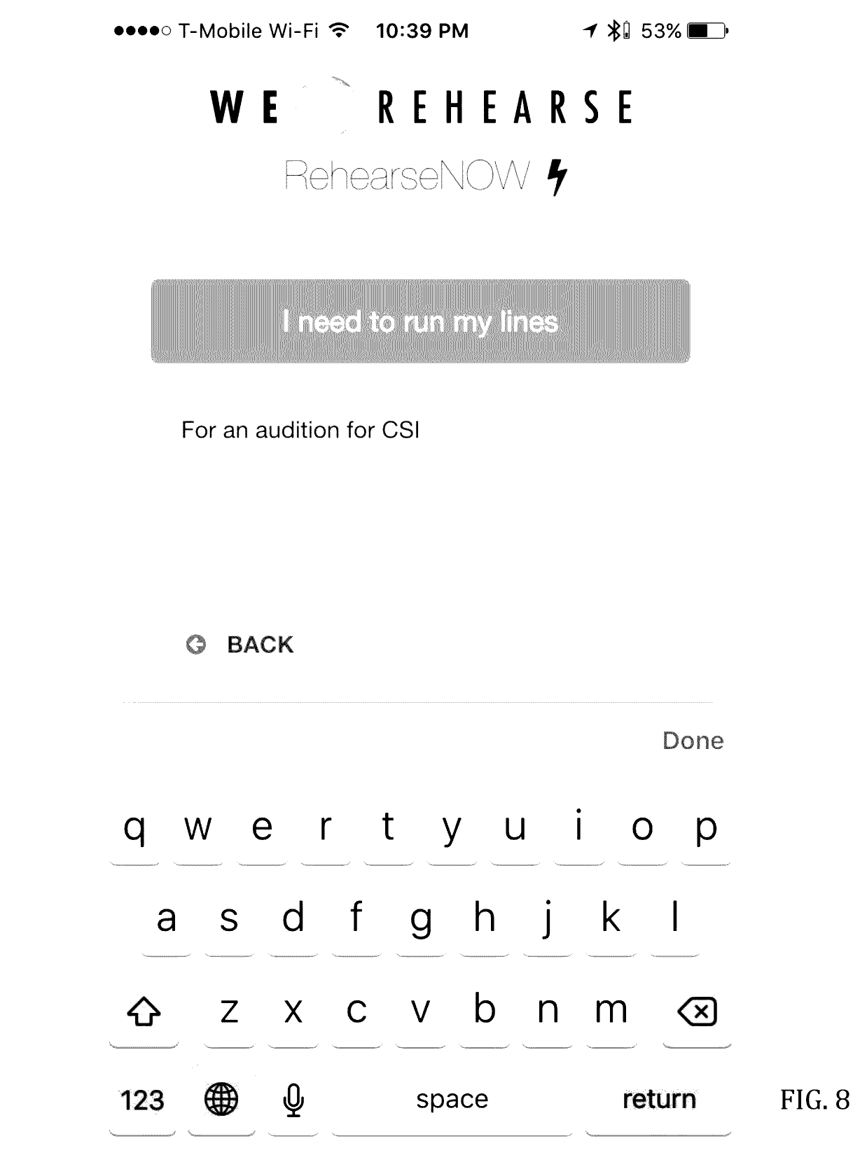

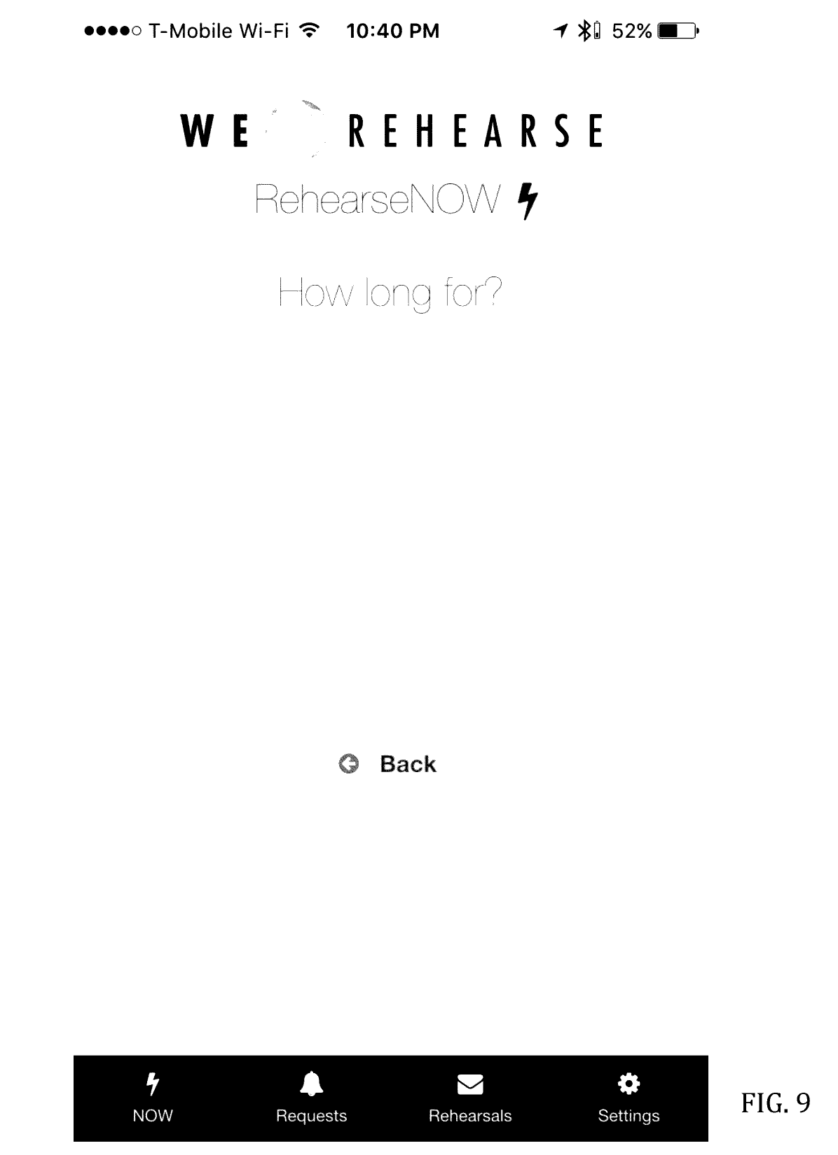

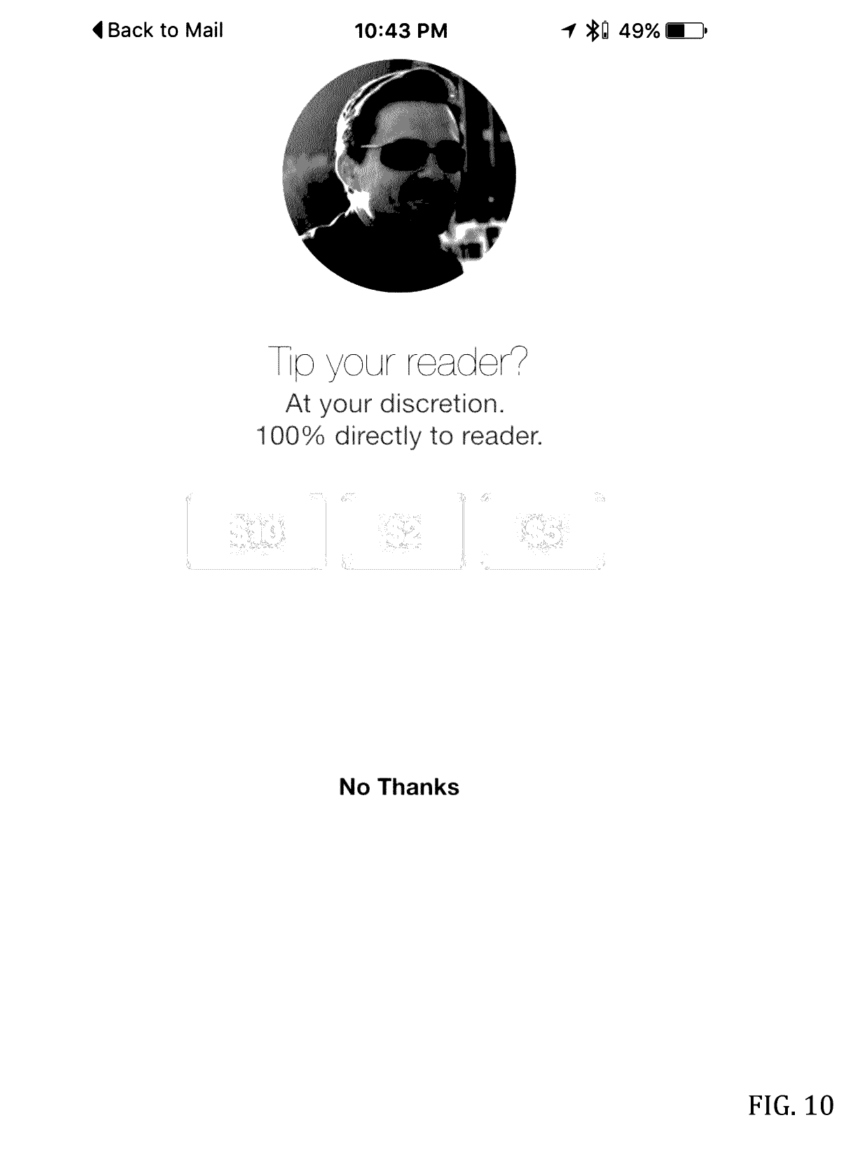

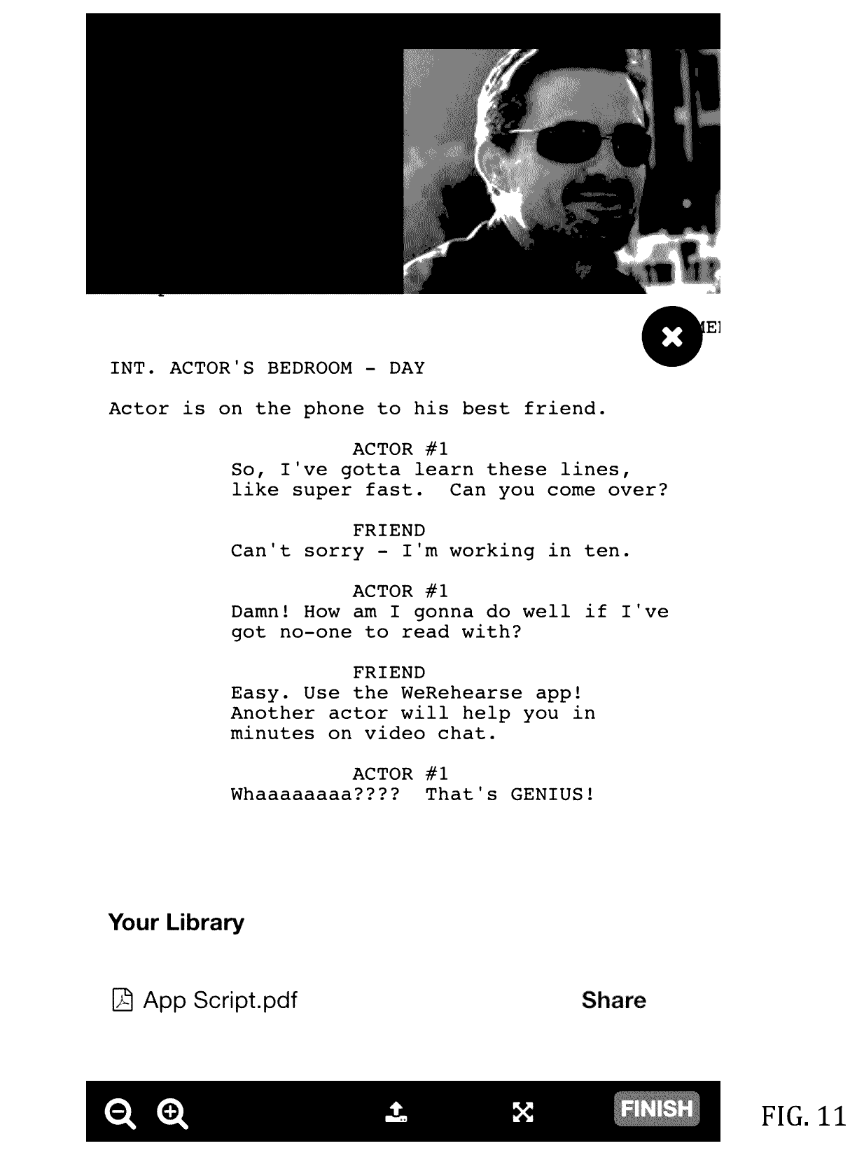

FIGS. 5-11 are exemplary screenshots of a mobile application embodying various aspects of the present invention. FIG. 5 shows an exemplary home screen for a mobile application embodying various aspects. A user can choose from a variety of options, including “RehearseNOW,” “Requests,” “Rehearsals,” and “Settings.” FIG. 6 shows an exemplary screen for rating a user. FIG. 7 shows an exemplary screen for user options of types of requests for the “RehearseNow” feature. FIG. 8 shows and exemplary screen of a user input screen where details of the request may be entered. FIG. 9 shows an exemplary screen for choosing a duration of time. FIG. 10 shows an exemplary screen for tipping a user. FIG. 11 shows an exemplary screen for sharing materials among users.

While the foregoing written description of the invention enables one of ordinary skill in the art to make and use the invention, those of ordinary skill in the art will understand and appreciate the existence of variations, combination, and equivalents of the embodiments, methods, and examples provided herein. The invention should, therefore, not be limited by the embodiments and examples disclosed here, but by all embodiments and methods within the scope and spirit of the invention as claimed. Moreover, it would be understood that the sequence of steps may vary without departing from the scope of the invention.

What is claimed is:

1. A system for online rehearsing for actors, comprising:
means for creating a profile of at least a first user and a second user, wherein said means comprises pre-formed questions specific to acting;
means for making said profile of said first user accessible to said second user;
means for selecting said profile of said first user;
means for viewing said profile of said first user comprising answers to said pre-formed questions specific to acting;
means for booking a rehearsal with said first user;
means for uploading one or more pieces of dramatic material, wherein said dramatic material is shared between said first and second users;
means for activating at least one first audiovisual capture device, wherein said first audiovisual capture device captures audiovisual data of said first user;
means for activating at least one second audiovisual capture device, wherein said second audiovisual capture device captures audiovisual data of said second user;
wherein said first and second audiovisual capture devices capture rehearsal of said dramatic material by said first and second user, wherein said first user or said second user perform in accordance with said dramatic material, wherein said rehearsal captured by said first and second audiovisual capture devices is streamed to said first user and said second user through online signal transmissions; and
means for effecting payment between said first and second user.

2. The system of claim 1, further comprising means for said first user to rate the performance of said second actor and means for said second user to rate the performance of said first user.

4. The system of claim 1, further comprising means for said second user to transfer a gratuity to said first user at the conclusion of said performance through said means for effecting payment.

5. A method for observing an online interactive acting event, comprising:
activating a device capable of streaming internet-based audiovisual signals;
activating an online profile;
searching for a scheduled online interactive acting event, wherein said online interactive acting event comprises at least one acting performance by one or more performers;
making a payment to view said online interactive acting event; and
observing said online interactive acting event.

6. The method of claim 5, further comprising the step of using said device to ask one or more questions, wherein said first user transmits written or verbal questions to said performer(s) and is able to receive a transmission in return consisting of at least one response by at least one performer.
